(19) United States
(12) Patent Application Publication
(10) Pub. No.: US 2025/0307543 A1
(43) Pub. Date: Oct. 2, 2025

(54) RESOURCE-EFFICIENT FOUNDATION MODEL DEPLOYMENT ON CONSTRAINED EDGE DEVICES

(71) Applicant: International Business Machines Corporation, Armonk, NY (US)

(72) Inventors: Aladin Djuhera, Dachau (DE); Syed Zawad, San Jose, CA (US); Fernando Luiz Koch, Palm Beach Gardens, FL (US); Alecio Pedro Delazari Binotto, Munich (DE); Martin Junghans, Karlsruhe (DE)

(21) Appl. No.: 18/623,195

(22) Filed: Apr. 1, 2024

(51) Int. Cl. G06F 40/20

(52) U.S. Cl. CPC G06F 40/20

(57) ABSTRACT

Computer-implemented methods for efficiently deploying foundation models on resource-constrained edge devices are disclosed herein. Aspects include receiving a text-based service request for an artificial intelligence (AI) model for an edge client. Aspects further include generating model and data descriptions using the text-based service request. Aspects also include generating an AI task capacity profile. Aspects further include selecting a resource-optimal AI model for deployment on the edge device based on the AI task capacity profile.

### BACKGROUND

The present invention generally relates to artificial intelligence and edge computing, and more specifically, to computer systems, computer-implemented methods, and computer program products for efficiently deploying foundation models on resource-constrained edge devices.

Foundation models are AI models that are trained on a broad set of unlabeled data that can be used for different tasks with minimal fine-tuning. Foundation models can be the foundation for many applications of the AI model. Using self-supervised learning and transfer learning, the model can apply information it has learned about one situation to another. In industrial, commercial, and private customer settings, edge devices can deploy complex foundation models for a single or short time use only for specific artificial intelligence (AI) tasks. The dynamic nature of such immediate and proprietary foundation model deployment requests require flexibility from a Foundation Model as a Service (FMaaS) platform when it comes to translating edge device requirements into AI model service requests.

### SUMMARY

Embodiments of the present invention are directed to a computer-implemented method for a system for resource-efficient foundation model deployment on constrained edge devices through generative prompt translation. According to an aspect of the invention, a computer-implemented method includes receiving a text-based service request for an artificial intelligence (AI) model for an edge device. The method also includes generating model and data descriptions using the text-based service request. The method further includes generating an AI task capacity profile. The method also includes selecting a resource-optimal AI model for deployment on the edge device based on the AI task capacity profile.

According to another non-limiting embodiment of the invention, a computer-implemented method includes receiving a service request for an artificial intelligence (AI) model for an edge device. The method also includes generating model and data specifications by using automated generative translations of the service request. The method further includes performing an AI task capacity profiling using the model and data specifications and a capacity profile of the edge device to identify a key performance parameter and a key resource parameter of the AI model. The method also includes selecting the AI for deployment on the edge device based on the key performance parameter and the key resource parameter.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 is a data flow diagram depicting the flow of data in a system that includes a system for resource-efficient foundation model deployment on constrained edge devices in accordance with one or more embodiments of the present invention;

FIG. 3 is a block diagram of a system for resource-efficient foundation model deployment on constrained edge devices in accordance with one or more embodiments of the present invention; and

FIG. 4 is a flowchart of a method for resource-efficient foundation model deployment on constrained edge devices in accordance with one or more embodiments of the present invention.

### DETAILED DESCRIPTION

Embodiments of the present invention are directed to a computer-implemented method for a system for resource-efficient foundation model deployment on constrained edge devices through generative prompt translation. According to an aspect of the invention, a computer-implemented method includes receiving a text-based service request for an artificial intelligence (AI) model for an edge device. The method also includes generating model and data descriptions using the text-based service request. The method further includes generating an AI task capacity profile. The method also includes selecting a resource-optimal AI model for deployment on the edge device based on the AI task capacity profile.

The above-described embodiments of the invention provide technical benefits and technical effects. For example, service requests for the deployment of AI models on edge devices that are non-standardized, text-based, and/or data-based prompts which cannot be interpreted by a Foundation Model as a Service (FMaaS) platform are often discarded or require additional review by an experienced AI expert to determine which AI model could satisfy the needs of the requesting client. Additionally, limited computing resources of an edge device can severely limit which AI model can be deployed onto the device. The embodiments are directed to automatically translating text-based client requirements into interpretable FMaaS requests using generative AI to ensure that service requests containing non-standardized, text-based, and/or data-based prompts are translated without the need for expert intervention or discarded. By identifying the key performance and resource parameters of AI models and comparing them to the capacity profiles of edge devices, resource-optimal AI model variants that balance the performance and resource utilization of the edge device are identified and deployed.

In one embodiment of the present invention, the text-based service request includes a description of an AI task, a description of an AI model architecture, a description of an input to the AI model, a description of an output of the AI model, an example of a deployment scenario of the AI model, an example of a specific use-case for the AI model, an example of a re-use of the AI model, a list of performance requirements of the AI model, or a list of generative prompts to the AI model.

The above-described embodiments of the invention provide technical benefits and technical effects. For example, embodiments of the invention are able to translate non-standardized, text-based, and/or data-based prompts which often cannot be interpreted by a Foundation Model as a Service (FMaaS) platform. Often times, such service requests are discarded or require additional review by an experienced AI expert to determine which AI model could satisfy the needs of the requesting client. Embodiments of the invention are able to use generative AI through a pre-trained large language model to extract information from the different types of non-standardized data in service requests into model and data descriptions to identify optimal AI models for deployment.

In one embodiment of the present invention, generating the model and data descriptions using the text-based service request further includes providing the text-based service request to a pre-trained large language model as input and generating the model and data descriptions using results received from the pre-trained large language model.

The above-described embodiments of the invention provide technical benefits and technical effects. For example, embodiments of the invention are able to translate non-standardized, text-based, and/or data-based prompts using generative AI through a pre-trained large language model to extract information from the different types of non-standardized data in service requests into detailed model and data descriptions to identify optimal AI models for deployment. By using generative AI, details from the text-based service requests are extracted and used to identify the optimal AI model to deploy on an identified edge device for the client.

In one embodiment of the present invention, generating the AI task capacity profile further includes retrieving a capacity profile of the edge device, identifying performance and resource parameters by comparing the capacity profile of the edge device to an AI model requirements mapping, and generating the AI task capacity profile using the performance and resource parameters.

The above-described embodiments of the invention provide technical benefits and technical effects. For example, embodiments of the invention use a capacity profile of the edge device as well as an AI model requirements mapping to ensure that the edge device is capable of executing the selected AI model.

In one embodiment of the present invention, the AI task capacity profile includes a compatibility list that includes hardware and software mismatches between a potential AI model and edge device or potential bottlenecks in memory, CPU, GPU, or software infrastructure of the edge device.

The above-described embodiments of the invention provide technical benefits and technical effects. For example, embodiments of the invention, the AI task capacity profile can include a compatibility list that is compiled by comparing the model and data descriptions generated from the service request and the capacity profile of the edge device of the client to identify potential AI models and corresponding hardware and software mismatches and possible performance issues that may arise. The compatibility list can be used to determine which AI models are the most likely to produce optimal performance results.

In one embodiment of the present invention, selecting the resource-optimal AI model for deployment on the edge device based on the AI task capacity profile further includes identifying an AI model family using the model and data descriptions and the AI task capacity profile and selecting a model variant of the AI model family based on the AI task capacity profile and resources of the edge device. In some embodiments, the model variant is a compressed, pruned, or quantized AI model to correspond to resources of the edge device.

The above-described embodiments of the invention provide technical benefits and technical effects. For example, embodiments of the invention are directed to identify AI models that are likely to meet the needs of the client based on their request and the capabilities and resources available on the edge device. In some embodiments, AI model families are identified that would satisfy client requirements. However, edge device capacity and resources may be unable to execute the AI model. By identifying the AI model family and the capacity and resources of the edge device, the invention can determine whether a model variant of the family, such as a compressed, pruned, and/or quantized AI model, could satisfy the client requirements when deployed on the edge device without sacrificing performance.

According to another non-limiting embodiment of the invention, a system having a memory having computer readable instructions and one or more processors for executing the computer readable instructions, the computer readable instructions controlling the one or more processors to perform operations. The operations include receiving a text-based service request for an artificial intelligence (AI) model for an edge device. The operations also include generating model and data descriptions using the text-based service request. The operations further include generating an AI task capacity profile. The operations also include selecting a resource-optimal AI model for deployment on the edge device based on the AI task capacity profile.

The above-described embodiments of the invention provide technical benefits and technical effects. For example, service requests for the deployment of AI models on edge devices that are non-standardized, text-based, and/or data-based prompts which cannot be interpreted by a Foundation Model as a Service (FMaaS) platform are often discarded or require additional review by an experienced AI expert to determine which AI model could satisfy the needs of the requesting client. Additionally, limited computing resources of an edge device can severely limit which AI model can be deployed onto the device. The embodiments are directed to automatically translating text-based client requirements into interpretable FMaaS requests using generative AI to ensure that service requests containing non-standardized, text-based, and/or data-based prompts are translated without the need for expert intervention or discarded. By identifying the key performance and resource parameters of AI models and comparing them to the capacity profiles of edge devices, resource-optimal AI model variants that balance the performance and resource utilization of the edge device are identified and deployed.

In one embodiment of the present invention, the text-based service request includes a description of an AI task, a description of an AI model architecture, a description of an input to the AI model, a description of an output of the AI model, an example of a deployment scenario of the AI model, an example of a specific use-case for the AI model, an example of a re-use of the AI model, a list of performance requirements of the AI model, or a list of generative prompts to the AI model.

The above-described embodiments of the invention provide technical benefits and technical effects. For example, embodiments of the invention are able to translate non-standardized, text-based, and/or data-based prompts which often cannot be interpreted by a Foundation Model as a Service (FMaaS) platform. Often times, such service requests are discarded or require additional review by an experienced AI expert to determine which AI model could satisfy the needs of the requesting client. Embodiments of the invention are able to use generative AI through a pre-trained large language model to extract information from the different types of non-standardized data in service requests into model and data descriptions to identify optimal AI models for deployment.

In one embodiment of the present invention, the operations to generate the model and data descriptions using the text-based service request further include providing the text-based service request to a pre-trained large language model as input and generating the model and data descriptions using results received from the pre-trained large language model.

The above-described embodiments of the invention provide technical benefits and technical effects. For example, embodiments of the invention are able to translate non-standardized, text-based, and/or data-based prompts using generative AI through a pre-trained large language model to extract information from the different types of non-standardized data in service requests into detailed model and data descriptions to identify optimal AI models for deployment. By using generative AI, details from the text-based service requests are extracted and used to identify the optimal AI model to deploy on an identified edge device for the client.

In one embodiment of the present invention, the operations to generate the AI task capacity profile further include retrieving a capacity profile of the edge device, identifying performance and resource parameters by comparing the capacity profile of the edge device to an AI model requirements mapping, and generating the AI task capacity profile using the performance and resource parameters.

The above-described embodiments of the invention provide technical benefits and technical effects. For example, embodiments of the invention use a capacity profile of the edge device as well as an AI model requirements mapping to ensure that the edge device is capable of executing the selected AI model.

In one embodiment of the present invention, the AI task capacity profile includes a compatibility list that includes hardware and software mismatches between a potential AI model and edge device or potential bottlenecks in memory, CPU, GPU, or software infrastructure of the edge device.

The above-described embodiments of the invention provide technical benefits and technical effects. For example, embodiments of the invention, the AI task capacity profile can include a compatibility list that is compiled by comparing the model and data descriptions generated from the service request and the capacity profile of the edge device of the client to identify potential AI models and corresponding hardware and software mismatches and possible performance issues that may arise. The compatibility list can be used to determine which AI models are the most likely to produce optimal performance results.

In one embodiment of the present invention, the operations to select the resource-optimal AI model for deployment on the edge device based on the AI task capacity profile further include identifying an AI model family using the model and data descriptions and the AI task capacity profile and selecting a model variant of the AI model family based on the AI task capacity profile and resources of the edge device. In some embodiments, the model variant is a compressed, pruned, or quantized AI model to correspond to resources of the edge device.

The above-described embodiments of the invention provide technical benefits and technical effects. For example, embodiments of the invention are directed to identify AI models that are likely to meet the needs of the client based on their request and the capabilities and resources available on the edge device. In some embodiments, AI model families are identified that would satisfy client requirements. However, edge device capacity and resources may be unable to execute the AI model. By identifying the AI model family and the capacity and resources of the edge device, the invention can determine whether a model variant of the family, such as a compressed, pruned, and/or quantized AI model, could satisfy the client requirements when deployed on the edge device without sacrificing performance.

According to another non-limiting embodiment of the invention, a computer program product for a system for resource-efficient foundation model deployment on constrained edge devices is provided. The computer program product includes a computer-readable storage medium having program instructions embodied therewith, the program instructions executable by a processor to cause the processor to perform operations. The operations include receiving a text-based service request for an artificial intelligence (AI) model for an edge device. The operations also include generating model and data descriptions using the text-based service request. The operations further include generating an AI task capacity profile. The operations also include selecting a resource-optimal AI model for deployment on the edge device based on the AI task capacity profile.

The above-described embodiments of the invention provide technical benefits and technical effects. For example, service requests for the deployment of AI models on edge devices that are non-standardized, text-based, and/or data-based prompts which cannot be interpreted by a Foundation Model as a Service (FMaaS) platform are often discarded or require additional review by an experienced AI expert to determine which AI model could satisfy the needs of the requesting client. Additionally, limited computing resources of an edge device can severely limit which AI model can be deployed onto the device. The embodiments are directed to automatically translating text-based client requirements into interpretable FMaaS requests using generative AI to ensure that service requests containing non-standardized, text-based, and/or data-based prompts are translated without the need for expert intervention or discarded. By identifying the key performance and resource parameters of AI models and comparing them to the capacity profiles of edge devices, resource-optimal AI model variants that balance the performance and resource utilization of the edge device are identified and deployed.

In one embodiment of the present invention, the text-based service request includes a description of an AI task, a description of an AI model architecture, a description of an input to the AI model, a description of an output of the AI model, an example of a deployment scenario of the AI model, an example of a specific use-case for the AI model, an example of a re-use of the AI model, a list of performance requirements of the AI model, or a list of generative prompts to the AI model.

The above-described embodiments of the invention provide technical benefits and technical effects. For example, embodiments of the invention are able to translate non-standardized, text-based, and/or data-based prompts which often cannot be interpreted by a Foundation Model as a Service (FMaaS) platform. Often times, such service requests are discarded or require additional review by an experienced AI expert to determine which AI model could satisfy the needs of the requesting client. Embodiments of the invention are able to use generative AI through a pre-trained large language model to extract information from the different types of non-standardized data in service requests into model and data descriptions to identify optimal AI models for deployment.

In one embodiment of the present invention, the operations to generate the model and data descriptions using the text-based service request further include providing the text-based service request to a pre-trained large language model as input and generating the model and data descriptions using results received from the pre-trained large language model.

The above-described embodiments of the invention provide technical benefits and technical effects. For example, embodiments of the invention are able to translate non-standardized, text-based, and/or data-based prompts using generative AI through a pre-trained large language model to extract information from the different types of non-standardized data in service requests into detailed model and data descriptions to identify optimal AI models for deployment. By using generative AI, details from the text-based service requests are extracted and used to identify the optimal AI model to deploy on an identified edge device for the client.

In one embodiment of the present invention, the operations to generate the AI task capacity profile further include retrieving a capacity profile of the edge device, identifying performance and resource parameters by comparing the capacity profile of the edge device to an AI model requirements mapping, and generating the AI task capacity profile using the performance and resource parameters.

The above-described embodiments of the invention provide technical benefits and technical effects. For example, embodiments of the invention use a capacity profile of the edge device as well as an AI model requirements mapping to ensure that the edge device is capable of executing the selected AI model.

In one embodiment of the present invention, the AI task capacity profile includes a compatibility list that includes hardware and software mismatches between a potential AI model and edge device or potential bottlenecks in memory, CPU, GPU, or software infrastructure of the edge device.

The above-described embodiments of the invention provide technical benefits and technical effects. For example, embodiments of the invention, the AI task capacity profile can include a compatibility list that is compiled by comparing the model and data descriptions generated from the service request and the capacity profile of the edge device of the client to identify potential AI models and corresponding hardware and software mismatches and possible performance issues that may arise. The compatibility list can be used to determine which AI models are the most likely to produce optimal performance results.

In one embodiment of the present invention, the operations to select the resource-optimal AI model for deployment on the edge device based on the AI task capacity profile further include identifying an AI model family using the model and data descriptions and the AI task capacity profile and selecting a model variant of the AI model family based on the AI task capacity profile and resources of the edge device. In some embodiments, the model variant is a compressed, pruned, or quantized AI model to correspond to resources of the edge device.

The above-described embodiments of the invention provide technical benefits and technical effects. For example, embodiments of the invention are directed to identify AI models that are likely to meet the needs of the client based on their request and the capabilities and resources available on the edge device. In some embodiments, AI model families are identified that would satisfy client requirements. However, edge device capacity and resources may be unable to execute the AI model. By identifying the AI model family and the capacity and resources of the edge device, the invention can determine whether a model variant of the family, such as a compressed, pruned, and/or quantized AI model, could satisfy the client requirements when deployed on the edge device without sacrificing performance.

According to another non-limiting embodiment of the invention, a computer-implemented method includes receiving a service request for an artificial intelligence (AI) model for an edge device. The method also includes generating model and data specifications by using automated generative translations of the service request. The method further includes performing an AI task capacity profiling using the model and data specifications and a capacity profile of the edge device to identify a key performance parameter and a key resource parameter of the AI model. The method also includes selecting the AI for deployment on the edge device based on the key performance parameter and the key resource parameter.

The above-described embodiments of the invention provide technical benefits and technical effects. For example, service requests for the deployment of AI models on edge devices that are non-standardized, text-based, and/or data-based prompts which cannot be interpreted by a Foundation Model as a Service (FMaaS) platform are often discarded or require additional review by an experienced AI expert to determine which AI model could satisfy the needs of the requesting client. Additionally, limited computing resources of an edge device can severely limit which AI model can be deployed onto the device. The embodiments are directed to automatically translating text-based client requirements into interpretable FMaaS requests using generative AI to ensure that service requests containing non-standardized, text-based, and/or data-based prompts are translated without the need for expert intervention or discarded. By identifying the key performance and resource parameters of AI models and comparing them to the capacity profiles of edge devices, resource-optimal AI model variants that balance the performance and resource utilization of the edge device are identified and deployed.

In one embodiment of the present invention, generating the model and data specifications by using the automated generative translations of the service request further includes providing the service request to a pre-trained large language model as input and generating the model and data specifications using results generated by the pre-trained large language model.

The above-described embodiments of the invention provide technical benefits and technical effects. For example, embodiments of the invention are able to translate non-standardized, text-based, and/or data-based prompts using generative AI through a pre-trained large language model to extract information from the different types of non-standardized data in service requests into detailed model and data descriptions to identify optimal AI models for deployment. By using generative AI, details from the text-based service requests are extracted and used to identify the optimal AI model to deploy on an identified edge device for the client.

According to another non-limiting embodiment of the invention, a system having a memory having computer readable instructions and one or more processors for executing the computer readable instructions, the computer readable instructions controlling the one or more processors to perform operations. The operations include receiving a service request for an artificial intelligence (AI) model for an edge device. The operations also include generating model and data specifications by using automated generative translations of the service request. The operations further include performing an AI task capacity profiling using the model and data specifications and a capacity profile of the edge device to identify a key performance parameter and a key resource parameter of the AI model. The operations also include selecting the AI for deployment on the edge device based on the key performance parameter and the key resource parameter.

The above-described embodiments of the invention provide technical benefits and technical effects. For example, service requests for the deployment of AI models on edge devices that are non-standardized, text-based, and/or data-based prompts which cannot be interpreted by a Foundation Model as a Service (FMaaS) platform are often discarded or require additional review by an experienced AI expert to determine which AI model could satisfy the needs of the requesting client. Additionally, limited computing resources of an edge device can severely limit which AI model can be deployed onto the device. The embodiments are directed to automatically translating text-based client requirements into interpretable FMaaS requests using generative AI to ensure that service requests containing non-standardized, text-based, and/or data-based prompts are translated without the need for expert intervention or discarded. By identifying the key performance and resource parameters of AI models and comparing them to the capacity profiles of edge devices, resource-optimal AI model variants that balance the performance and resource utilization of the edge device are identified and deployed.

In one embodiment of the present invention, the operations to generate the model and data specifications by using the automated generative translations of the service request further include providing the service request to a pre-trained large language model as input and generating the model and data specifications using results generated by the pre-trained large language model.

The above-described embodiments of the invention provide technical benefits and technical effects. For example, embodiments of the invention are able to translate non-standardized, text-based, and/or data-based prompts using generative AI through a pre-trained large language model to extract information from the different types of non-standardized data in service requests into detailed model and data descriptions to identify optimal AI models for deployment. By using generative AI, details from the text-based service requests are extracted and used to identify the optimal AI model to deploy on an identified edge device for the client.

Additional technical features and benefits are realized through the techniques of the present invention. Embodiments and aspects of the invention are described in detail herein and are considered a part of the claimed subject matter. For a better understanding, refer to the detailed description and to the drawings.

Disclosed herein are methods, systems, and computer program products for a system for resource-efficient foundation model deployment on constrained edge devices through generative prompt translation. As discussed above, foundation models are artificial intelligence (AI) models that are trained on a broad set of unlabeled data that can be used for different tasks with minimal fine-tuning. In some embodiments, a client includes numerous edge sites. Edge sites of clients can include antennas and edge devices.

Foundation Model as a Service (FMaaS) platforms deploy AI models on edge devices of clients. The FMaaS platforms maintains a primary AI model and also maintains iteratively compressed, pruned, quantized, and/or altered versions of the AI model, known as model variants. The AI model variants can offer reduced performance compared to the primary AI model but that are compatible with resource-constrained edge devices of a client. By incorporating adaptable model iterations in FMaaS repositories, the versatility of the platform is expanded while catering to a broader spectrum of heterogeneous edge devices of clients.

In some embodiments, clients request AI models, data processing features, or other machine learning services while having non-standardized, text-based, or data-based prompts which cannot be automatically translated by an FMaaS instance of an FMaaS platform. The service requests that cannot be easily categorized due to novel AI tasks or are not specified accurately enough by an unfamiliar user can be discarded or needs to be reviewed by experienced AI experts in order to determine which model and/or service satisfies the intricate client needs. Furthermore, deployment can be difficult because of the non-standardized and proprietary client prompts and limited computing resources at the edge device such that not every available AI model can be fully deployed. AI models may need to undergo pruning, compression, and/or other alterations while balancing a tradeoff between the AI model performance and edge device resource utilization.

The systems and methods described herein are directed to a foundation model deployment system able to translate complex, non-standardized and specific edge device requirements into appropriate AI model service requests and the subsequent resource-efficient deployment of those AI models onto the constrained edge device. The foundation model deployment system can automatically translate text-based client requirements into interpretable FMaaS requests using automated generative translations using pre-trained large language models. The foundation deployment system also automatically identifies key performance indicators for AI model deployment to identify potential bottlenecks with regards to available edge resources. The foundation model deployment system also identifies AI model variants for client edge devices based on the requirements from the client and capabilities of the edge device using resource-optimal model selection which balance performance and resource utilization by the edge device.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

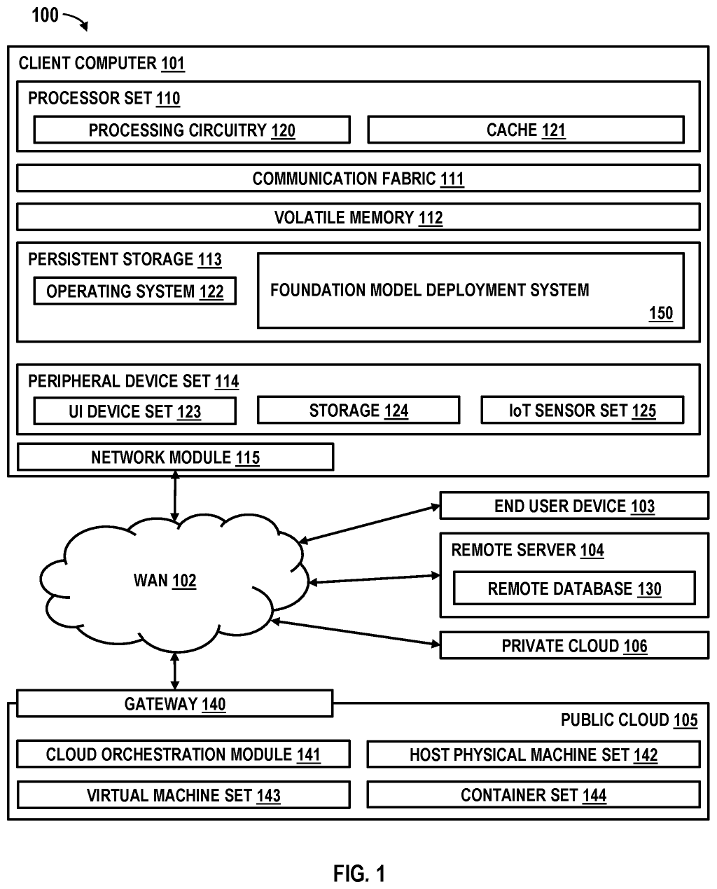

Referring now to FIG. 1, computing environment 100 contains an example of an environment for the execution of at least some of the computer code involved in performing the inventive methods, such as translating text-based client requirements into interpretable FMaaS requests using generative AI, identifying key AI model deployment KPIs to determine bottlenecks with regards to available edge resources, and deploying resource-optimal AI model variants by a foundation model deployment system 150. In addition to the foundation model deployment system 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and the foundation model deployment system 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Client computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the foundation model deployment system 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in the foundation model deployment system 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collects and stores helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

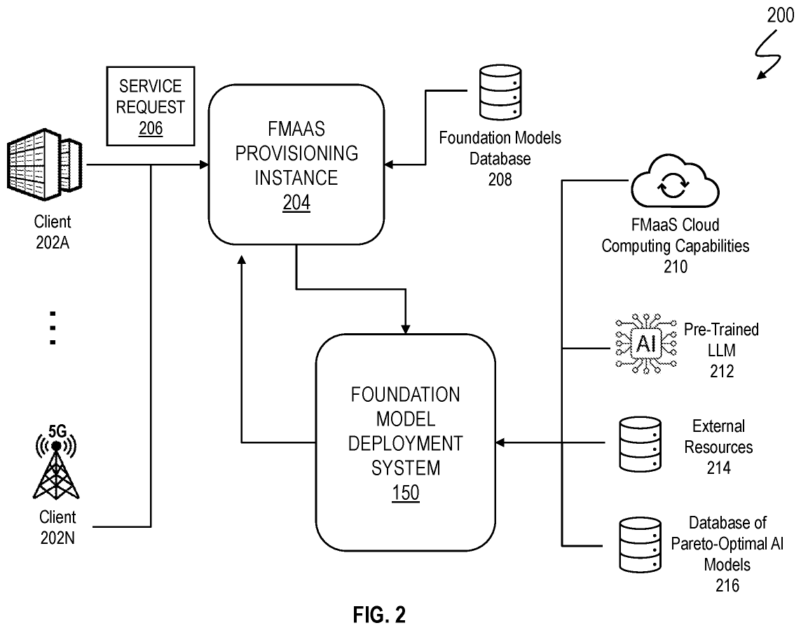

Referring now to FIG. 2, a data flow diagram depicting the flow of data in system 200 that includes a foundation model deployment system 150 in accordance with one or more embodiments of the present invention. As depicted in FIG. 2, client 202A is an on-site data center that has a high-performance client edge device that can run a large AI model. In some embodiments, client 202A generates and transmits a service request 206 to an FMaaS provisioning instance 204 of an FMaaS platform. An FMaaS platform deploys AI models on edge devices of a client, such as client 202A or 202N. The FMaaS provisioning instance 204 maintains a primary AI model and also maintains iteratively compressed, pruned, quantized, and/or altered versions of the AI model, known as model variants. The AI model variants can offer reduced performance compared to the primary AI model but that are compatible with resource-constrained edge devices of a client 202. By incorporating adaptable model iterations in FMaaS repositories, such as foundation models database 208, the versatility of the platform is expanded while catering to a broader spectrum of heterogeneous edge devices of clients 202.

The FMaaS provisioning instance 204 handles AI model requests from client 202A and/or client 202N (collectively or singularly referred to as “client 202”), provisions new and adapted AI model variants, and maintains and updates the foundation models database, such as foundations models database 208. The FMaaS provisioning instance 204 transmits the service request 206 to a foundation model deployment system 150.

In some embodiments, the service request 206 is a plain text description or corresponding prompts that include client requirements, prompts, and/or other requested features on an AI model to be deployed on an edge device of a client 202. For example, the service request 206 can include a description of an AI task, such as classification, regression, time-series, natural language processing (NLP), or the like. In some embodiments, the service request 206 is a description of an AI model architecture, such as neural networks, transformers, long short-term memory network (LSTM), support vector machines, or the like. In some examples, a service request 206 can include a description of the input to be provided to the AI model deployed on the edge device of the client 202, such as data types, data distribution, amount of data, or the like. Similarly, the service request 206 can include a description of the desired output of the AI model to be deployed on the edge device of the client 202, such as numerical data, audio data, text data, media, prompts, and the like. Other examples of information that can be included in a service request 206 include, but are not limited to, an example of the deployment scenario of the model (e.g. IoT, servers, workstations, etc.), an example of a specific use-case for the AI model (e.g. business plan, real-world case study, etc.), an example of a potential re-use of the model (e.g. fine-tuning on different tasks incorporation of feedback loops, etc.), a list of performance requirements of the model (e.g. accuracy, latency, size, etc.), a list of generative prompts to the model (e.g. “this model should do A, then proceed with doing B, incorporating C, . . . ”), or any other suitable description of model and task features.

The foundation model deployment system 150 receives and translates the service request 206 into model and services descriptions using, for example, a pre-trained large language model (LLM) 212 for automated generative translation (AGT) and information of the FMaaS cloud computing capabilities 210. The foundation model deployment system 150 uses the model and services descriptions to identify key performance and resource parameters for the deployment of AI models at one or more edge devices of a client 202A. In some embodiments, the foundation model deployment system 150 uses external resources 214 to identify the key performance and resource parameters. In some embodiments, the foundation model deployment system 150 determines which AI model variant to deploy to an edge device of a client 202A based on the edge device capacity requirements. In some embodiments, the foundation model deployment system 150 uses a database of pareto-optimal AI models 216 to select an AI model variant for deployment. The foundation model deployment system 150 transmits the identified AI model variant to the FMaaS provisioning instance 204. The FMaaS provisioning instance 204 receives the selection from the foundation model deployment system and provisions the identified AI model variant to the edge device of the client 202A.

Similarly, client 202N is a smaller client that has a low-performance client edge device that can run compact AI model variants. A service request 206 is received from client 202N, the FMaaS provisioning instance 204 receives and transmits the service request 206 to the foundation model deployment system 150. The foundation model deployment system 150 translates the service request, identifies key performance and resource parameters based on the service request 206 and the edge client of client 202N, and uses a database of pareto-optimal AI models 216 to select an AI model variant corresponding to the requirements of the edge device of client 202N for deployment. The foundation model deployment system 150 transmits the identified AI model variant to the FMaaS provisioning instance 204. The FMaaS provisioning instance 204 receives the selection from the foundation model deployment system and provisions the identified AI model variant to the edge device of the client 202N.

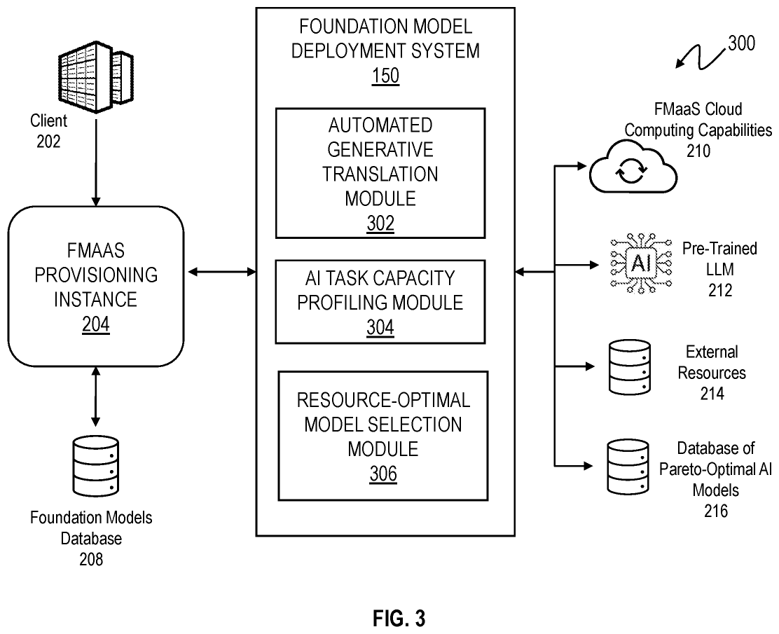

Referring now to FIG. 3, a system 300 for a foundation model deployment system 150 in accordance with one or more embodiments of the present invention is shown. In exemplary embodiments, the system 300 includes foundation model deployment system 150 that may be embodied in a computer 101, such as the one shown in FIG. 1. As illustrated, the system 300 includes the foundation model deployment system 150 that is associated with one or more FMaaS provisioning instances 204 of an FMaaS platform. The FMaaS provisioning instance 204 receives a service request from a client 202 that is transmitted to the foundation model deployment system 150. In some embodiments, the foundation model deployment system 150 includes an automated generative translation (AGT) module 302, an AI task capacity profiling (ACP) module 304, and/or a resource-optimal model selection (RMS) module 306.

In some embodiments, the foundation model deployment system 150 receives the service request 206 of the client 202 from the FMaaS provisioning instance 204. The AGT module 302 receives the service request 206 and translates the client requirements, prompts, and other requested features in the service request 206 into suitable AI model and service descriptions or model and service specifications, such as a configuration or JSON file that can be interpreted by the FMaaS provisioning instance 204. In some embodiments, the AGT module 302 uses a pre-trained large language model (LLM), such as pre-trained LLM 212, to transform the service request 206 into model and service descriptions.

In some embodiments, a pre-trained LLM 212 is designed to comprehend, summarize, and transform the service request 206 into meaningful inputs (e.g., model and service descriptions) for the FMaaS provisioning instance 204. In some embodiments, the pre-trained LLM is fine-tuned on existing open-source AI models (e.g., BERT, GPT, Llama, Falcon, etc.), existing closed-source offerings (e.g., OpenAI, etc.), prompts and hard-coded examples of desired inputs and outputs (e.g. descriptions on the model and data cards, specific examples of those, etc.), historical data (i.e. client requests which are mapped to their corresponding model and data cards from previous case studies, FMaaS client databases, other consulting efforts, etc.) and/or synthesized data and variations of the data (i.e. potential client requests and predicted mappings to model and data cards from ongoing business trends, current innovations in AI, state-of-the-art case studies, other examples of novel AI tasks, etc.).

In some embodiments, the pre-trained LLM 212 is evaluated on appropriate train-validation data splits or never seen before client requests or by AI experts, consultants and FMaaS business leaders. In some embodiments, the pre-trained LLM 212 incorporates a feedback loop for continuous model improvement, re-training, and fine-tuning. In some embodiments, the pre-trained LLM outputs a generic dictionary for model and data cards which can be understood by data-centric pre-processing entities capable of working with dictionaries. In some embodiments, pre-trained LLM 212 can contain key-value pairs. Keys can include entries such as AI task, model architecture, input, output, deployment scenario, use-case, performance requirements, prompts, and other features. Values can include text-based descriptions or pre-defined features which are intelligible by the FMaaS (e.g. proprietary naming schemes, shorthand, etc.).

In some embodiments, the AGT module 302 implements an automated generative translation of the service request 206 by collecting the plain text descriptions from the service request 206 and providing the plain text descriptions from the service request 206 as input to the pre-trained LLM 212. The AGT module 302 generates the model and service descriptions (also referred to as model and service specifications or model and service cards) using the results generated by the pre-trained LLM 212 from the plain text from the service request 206. In some embodiments, the model and service descriptions include key-value pairs for AI model tasks, type, use-case, input-output data distributions, and the like.

In some embodiments, the AGT module 302 post processes the output dictionaries for the generated model and service descriptions. The post-processing can include data formatting, serialization, and/or other methods of data post-processing. In some embodiments, the AGT module 302 encrypts sensitive user data in the model and service descriptions. In some embodiments, the AGT module 302 can include the integration of the model and service descriptions into a specific application programming interface (API) to the FMaaS provisioning instance 204. The AGT module 302 forwards the post-processed model and data descriptions to the ACP module 304.

The ACP module 304 of the foundation model deployment system 150 receives the model and data descriptions from the AGT module 302. The ACP module 304 performs a capacity profiling of the requested edge device of the client 202 and determines the key resource parameters which define the feasibility of an AI model deployment onto the constrained edge device of the client 202. The ACP module 304 uses the model and service description generated by the AGT module 302 to align model or use-case specific requirements, such as additional memory, storage, minimum processor/network bandwidth, or the like, to profile the capacity demands for the requested AI-based workload from the service request 206.

In some embodiments, the ACP module 304 retrieves a capacity profile of the edge device identified in the service request 206. The capacity profile of the edge device can include, but is not limited to, hardware specifications (e.g. CPU, GPU, RAM, storage, etc.) of the edge device, network capabilities (e.g. bandwidth, latency, etc.) of the edge device, power consumption information (e.g., limits, battery status, etc.) of the edge device, operating system and other software constraints of the edge device, and/or supported AI model formats and available inference engines (e.g., CUDA, TinyML, TensorFlow Lite, etc.) of the edge device. In some embodiments, the capacity profile of the edge device is received from the client 202 or stored in a database of the FMaaS provisioning instance 204.

In some embodiments, the ACP module 304 retrieves one or more AI model requirements mappings. AI model requirements mappings include the requirements of a specific model architecture, task, and/or data. In some embodiments, AI requirement mappings utilize a database of known AI model architectures or AI model tasks and their corresponding hardware and/or software requirements. AI model requirements mappings can be further augmented by using historical data (e.g. previous deployments of AI models and their known requirements. In some embodiments, AI model requirements mappings are further augmented by external resources, such as external resources 214. Examples of external resources 214 can include, but are not limited to, external databases, public AI model repositories, public benchmarks detailing performance metrics of various AI models on different hardware or the like. In some embodiments, the AI model requirements mappings can be augmented by hardware and/or software requirements associated with a specific AI model use-case. In some embodiments, the AI model requirements mappings are augmented by advanced hardware knowledge (e.g., recognized insights about certain AI model types such as Transformers, DNNs, and the like, which are known to be GPU intensive). In some embodiments, the AI model requirements mappings are augmented by advanced software knowledge (e.g., AI models that perform best on certain software stacks due to optimizations such as CUDA, TinyML, TensorFlow Lite, etc.). In some embodiments, AI model requirements mappings are automated by a populating neural network, decision tree, large language model using the inputs described herein.

In some embodiments, the ACP module 304 performs an AI task capacity profiling by comparing the capacity profile of the edge device of the requesting client 202 with an AI model requirements mapping for a given AI model architecture and/or task. The ACP module 304 compiles a compatibility list of the hardware and software stack of the edge device of the client 202 against the recommended requirements of an AI model based on the AI model requirements mapping. In some embodiments, the ACP module 304 identifies the hardware and software mismatches between the AI model and the edge device. The ACP module 304 identifies potential bottlenecks in the memory, CPU, GPU, and/or software infrastructure of the edge device. The ACP module 304 generates an AI task capacity profile that includes identified key performance and resource parameters for the deployment and usage of the requested AI model on the edge device of the client 202.

In some embodiments, the ACP module 304 uses a predictive analysis of the potential model performance of the AI model once deployed on the edge device without optimization. The ACP module 304 can use historical data for the predictive analysis. In some embodiments, the ACP module 304 uses machine learning models, such as regression, classification, time-series, and/or the like in the predictive analysis of the potential model performance of the AI model.

In some embodiments, the ACP module 304 provides one or more recommendations for AI models for deployment on the identified edge device of the client 202. In some embodiments, the recommendations are based on the identified bottlenecks in performance. In some embodiments, the recommendations can include model pruning, quantization, alternative AI model deployment and the like. The recommendations can be augmented by expert knowledge research outcomes, and/or information obtained from external resources, such as public databases.

The RMS module 306 of the foundation model deployment system 150 receives the model and data descriptions from the AGT module 302 and the AI task capacity profile from the ACP module 304. The RMS module 306 compares the model and data descriptions with existing AI models within the FMaaS platform, determines the correct family of AI models based on the AI task capacity profile and the model and data descriptions, and provisions the resource-optimal version of the AI model (e.g. a specifically designed, compressed, pruned, quantized, etc. version) by selecting the AI model that best matches the features requested in the service request 206 and the capacity of the edge device of the client 202. In some embodiments, the RMS module 306 uses a method for pareto-optimal AI model deployment. The RMS module 306 determines, provisions, and aids in the deployment of an AI model variant based on available edge device resources. In some embodiments, the RMS module 306 uses the capacity profile of an identified edge device to determine the edge device capabilities (e.g., memory, computation power, etc.) and desired latency bounds to identify the best performing AI model for deployment on the edge device using a Pareto-optimality prediction curve, resulting in provisioning of the most optimal AI model variant on the edge device of the client 202 which balances model performance and available resources. Additionally details and discussion of using a pareto-optimal configuration curve to select an optimal AI model is described in U.S. patent application Ser. No. 18/531,518 filed on Dec. 6, 2023, which is herein incorporated by reference in its entirety. In some embodiments, the RMS module 306 selects an AI model for deployment on the edge device of the client 202 by generating a wide range of model architectures across fine-grained hardware requirements of the edge device, such as memory, power consumption, and the like. The RMS module 306 derives a Pareto-optimal configuration curve for the tradeoff between model latency and model task performance. The RMS module 306 determines an AI model variant based on the identified edge device capacity requirements by consulting the Pareto-optimal decision curve and, if necessary, computing a more optimal AI model variant based on this Pareto-optimal baseline. This process identifies the best possible AI model variant (e.g., compressed, pruned, quantized, and/or otherwise altered), which accounts for the limited resources of the edge device while balancing the tradeoff between model performance and latency.

The RMS module 306 directs the FMaaS provisioning instance 204 to select the most optimal AI model configuration for the deployment of the AI model at the edge device by identifying the correct AI model family and matching the corresponding sub-model using the detailed model and data descriptions from the AGT module 302 by matching the AI model type, task, use-case, etc. from the provided model and data key-value pairs. In some embodiments, the RMS module 306 identifies the critical edge device resource parameters, which might hinder the deployment of the selected model. In some embodiments, the FMaaS provisioning instance 204 can choose to save this model to an existing database, such as foundations models database 208. The FMaaS provisioning instance 204 can us the foundations models database 208 to deploy the same model to other edge devices and may provide feedback and further information on the requirements and capabilities of the AI model to the ACP module 304 for future use.

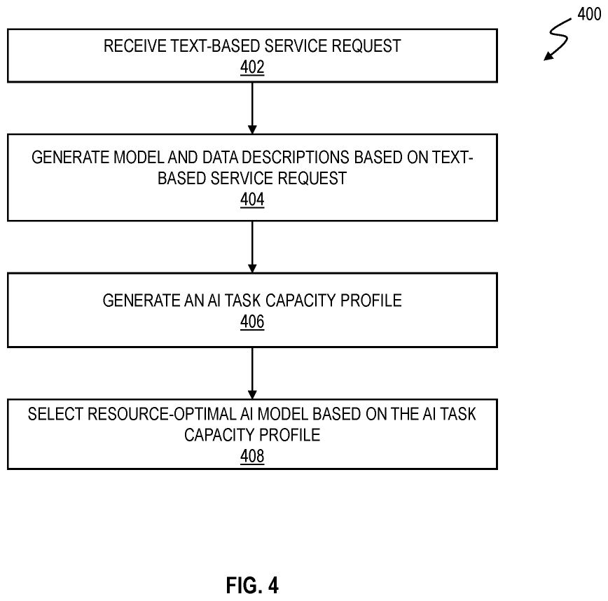

Referring now to FIG. 4, a flowchart of a method 400 for resource-efficient foundation model deployment on constrained edge devices in accordance with one or more embodiments of the present invention is shown. The method 400 begins at block 402 by receiving a text-based service request 206. In some embodiments, the service request 206 is a plain text description or corresponding prompts that include client requirements, prompts, and/or other requested features on an AI model to be deployed on an edge device of a client 202.

For example, a retail company wants to deploy an AI model on their in-store cameras to recognize and categorize customer emotions for better in-store promotions. A client 202 of the retail company generates and transmits a text-based service request 206 received to the FMaaS provisioning instance 204. The service request 206 includes the text “We want a model to recognize customer emotions from our in-store CCTV cameras to offer real-time promotions. It should detect happiness, sadness, surprise, and anger. This will help us in tailoring promotional content. Also, the solution should be real-time.”

Next at block 404, the foundation model deployment system 150 generates a model and description based on the text-based service request 206 received from the client 202. In some embodiments, the AGT module 302, receives the text-based service request 206 and generates a model and description. In some embodiments, the AGT module 302 module utilizes a pre-trained LLM 212 to translate the text-based service request 206 into model and data descriptions which can be interpreted by the FMaaS provisioning instance 204 and the foundation model deployment system 150. In some embodiments, the text-based service request 206 is provided to the pre-trained LLM 212 as input and the model and data descriptions are generated. The model and data descriptions can be stored as configuration or JSON files. An example of model and data descriptions based on the example text-based service request 206 is depicted in Table 1.

TABLE 1
Example model and data descriptions

| Description | Value |
|---|---|
| AI Task | Emotion recognition |
| Model Architecture | Convolutional Neural Network (CNN) |
| Input | Image frames from CCTV cameras |
| Ouput | Emotion categories (happiness, |
| | sadness, surprise, anger) |
| Deployment Scenario | In-store edge devices connected to cameras |
| Use-Case | Real-time promotional content tailoring |
| Performance | Real-time inference (<500 ms per frame) |
| Requirements | |

Next at block 406, the foundation model deployment system 150 generates an AI task capacity profile. The ACP module 304 receives the model and data descriptions generated by the AGT module 302 and identifies key performance and resource parameters for the deployment and usage of a requested AI model. The ACP module 304 retrieves or obtains a capacity profile associated with the edge device identified from the service request 206. An example capacity profile for an edge device of a client 202 is depicted in Table 2.

TABLE 2
Example capacity profile for edge device

| Description | Value |
|---|---|
| CPU | Dual-core 1.8 GHz |
| GPU | Not Available |
| RAM | 4 GB DDR3 |
| Storage | 128 GB SSD |
| Network | Stable 5 Mbps connections |
| OS | Linux-based custom OS |
| Supported AI frameworks | TensorFlow Lite, ONNX |

Additionally, the ACP module 304 generates or obtains an AI model requirements mapping, such as the example depicted in Table 3. The AI model requirements mapping identifies the most important requirements of a specific AI model architecture, AI task, or data identified in the service request 206. In some embodiments, the ACP module 304 utilizes external resources 214, such as a database of known model architectures or model tasks and their corresponding hardware and software requirements. The information in the AI requirements mapping can be augmented using different information, such as historical data, external databases, hardware and software requirements of a specific model use-case, advance hardware knowledge, and/or advanced software knowledge.

TABLE 3
Example AI model requirements mapping

| Description | Value |
|---|---|
| AI Model | CNN for Emotion Recognition |
| Hardware | Prefers GPU but can run on CPU. Needs at least |
| | 2 GB RAM |
| Software | TensorFlow, PyTorch, or ONNX compatible. Real- |
| | time demands optimized libraries like TensorFlow Lite |

The ACP module 304 generates an AI task capacity profile, such as the one depicted in Table 4, by comparing the capacity profile of the edge device of the client 202 with the AI model requirements mapping for the identified AI model architecture and/or task and compiling a compatibility list of the hardware/software stack of the edge device against the recommended requirements of the AI model requirements mapping. In some embodiments, the compatibility list outlines the most crucial hardware and software mismatches of a potential AI model and the edge device of the client and identifies potential bottlenecks in memory, CPU, GPU, or software infrastructure of the edge device based on the potential AI model. In some embodiments, the compatibility list is part of the AI task capacity profile.

TABLE 4
Example AI task capacity profile

| Description | Value |
|---|---|
| Most Crucial Hardware | CPU (since GPU is unavailable), RAM |
| Most Crucial Software | TensorFlow Lite (for optimized |
| | real-time inference) |

Next at block 408, the foundation model deployment system 150 selects a resource-optimal AI model based on the AI task capacity profile. In some embodiments, the RMS module 306 selects an optimal AI model for deployment on the edge device of the client 202. The RMS module 306 receives and/or accesses the model and data descriptions generated by the AGT module 302. The model and data descriptions include key-value pairs for AI model tasks, AI model type, use-case information, input-output data distributions, and the like. The RMS module 306 also receives and/or accesses the AI task capacity profile generated by the ACP module 304 which includes the key performance and resource parameters with regards to the deployment and usage of a requested AI model. In some embodiments, the RMS module 306 utilizes a method for Pareto-optimal AI model deployment which identifies and selects an AI model variant based on the capacity requirements of the edge device of the client 202 by consulting a Pareto-optimal decision curve, and if necessary, computing a more optimal AI model variant based on the Pareto-optimal baseline.

The RMS module 306 is able to identify and select the most optimal AI model variant (e.g., compressed, pruned, quantized, and/or otherwise altered) which accounts for the limited resources of the edge device of the client 202 while balancing the tradeoff between the performance of the AI model and its latency. In some embodiments, the RMS module 306 selects the optimal AI model by identifying the correct AI model family and matching the corresponding sub-model using the model and data descriptions generated by the AGT module 302. For example, the RMS module 306 can match the AI model type, AI task, use-case, etc. from the key-value pairs in the model and data descriptions. The RMS module 306 uses the AI task capacity profile generated by the ACP module 304 to identify the most critical edge device resource parameters, which might hinder the deployment of the selected AI model. An example of the different information that is used to select the optimal AI model for the edge device is depicted in Table 5.

TABLE 5
Example model selection data

| Description | Value |
|---|---|
| Selected AI Model Family | Emotion Recognition CNNs |
| Matching with Sub-Model | A lightweight CNN model optimized for |
| | emotion recognition on edge devices |
| Consultation of ACP | Given the edge device lacks GPU, a CPU- |
| recommendations | optimized model variant is necessary. |
| | Additionally, the model should be small |
| | enough to ensure real-time processing |
| | with the available RAM |
| Pareto-Optimal AI | The system identifies a pruned version of |
| Model Selection | the emotion recognition CNN which has |
| | been quantized for faster CPU inference |
| | but still maintains acceptable accuracy. |
| | This model variant is Pareto-optimal for |
| | the given constraints |
| FMaaS Selection | The system chooses the pruned and |
| | quantized emotion recognition CNN |
| | model, packaged for deployment with |
| | TensorFlow Lite, ensuring compatibility |
| | with the edge device's software stack |

In some embodiments, the RMS module 306 transmits or otherwise communicates the selection of the AI model variant to the FMaaS provisioning instance 204. The FMaaS provisioning instance 204 saves the model into the foundation models database 208. In some embodiments, the FMaaS provisioning instance 204 uses the foundation models database 208 to deploy the selected AI model variant to the edge device of the client 202 or other edge devices of the client 202. The FMaaS provisioning instance 204 can provide feedback and further information on the AI model requirements and capabilities to the ACP module 304, which can be stored, for example, in the FMaaS cloud computing capabilities 210 for future use.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram, or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a text-based service request for an artificial intelligence (AI) model for an edge device;
generating model and data descriptions using the text-based service request;
generating an AI task capacity profile; and
selecting a resource-optimal AI model for deployment on the edge device based on the AI task capacity profile.

2. The computer-implemented method of claim 1, wherein the text-based service request comprises a description of an AI task, a description of an AI model architecture, a description of an input to the AI model, a description of an output of the AI model, an example of a deployment scenario of the AI model, an example of a specific use-case for the AI model, an example of a re-use of the AI model, a list of performance requirements of the AI model, or a list of generative prompts to the AI model.

3. The computer-implemented method of claim 1, wherein generating the model and data descriptions using the text-based service request further comprises:
providing the text-based service request to a pre-trained large language model as input; and
generating the model and data descriptions using results received from the pre-trained large language model.

4. The computer-implemented method of claim 1, wherein generating the AI task capacity profile further comprises:
retrieving a capacity profile of the edge device;
identifying performance and resource parameters by comparing the capacity profile of the edge device to an AI model requirements mapping; and
generating the AI task capacity profile using the performance and resource parameters.

5. The computer-implemented method of claim 1, wherein the AI task capacity profile comprises a compatibility list that comprises hardware and software mismatches between a potential AI model and edge device or potential bottlenecks in memory, CPU, GPU, or software infrastructure of the edge device.

6. The computer-implemented method of claim 1, wherein selecting the resource-optimal AI model for deployment on the edge device based on the AI task capacity profile further comprises:
identifying an AI model family using the model and data descriptions and the AI task capacity profile; and
selecting a model variant of the AI model family based on the AI task capacity profile and resources of the edge device.

7. The computer-implemented method of claim 6, wherein the model variant is a compressed, pruned, or quantized AI model to correspond to resources of the edge device.

8. A system comprising:
a memory having computer readable instructions; and
one or more processors for executing the computer readable instructions, the computer readable instructions controlling the one or more processors to perform operations comprising:
receiving a text-based service request for an artificial intelligence (AI) model for an edge device;
generating model and data descriptions using the text-based service request;
generating an AI task capacity profile; and
selecting a resource-optimal AI model for deployment on the edge device based on the AI task capacity profile.

9. The system of claim 8, wherein the text-based service request comprises a description of an AI task, a description of an AI model architecture, a description of an input to the AI model, a description of an output of the AI model, an example of a deployment scenario of the AI model, an example of a specific use-case for the AI model, an example of a re-use of the AI model, a list of performance requirements of the AI model, or a list of generative prompts to the AI model.

10. The system of claim 8, wherein the operations to generate the model and data descriptions using the text-based service request further comprise:
providing the text-based service request to a pre-trained large language model as input; and
generating the model and data descriptions using results received from the pre-trained large language model.

11. The system of claim 8, wherein the operations to generate the AI task capacity profile further comprise:
retrieving a capacity profile of the edge device;
identifying performance and resource parameters by comparing the capacity profile of the edge device to an AI model requirements mapping; and
generating the AI task capacity profile using the performance and resource parameters.

12. The system of claim 8, wherein the AI task capacity profile comprises a compatibility list that comprises hardware and software mismatches between a potential AI model and edge device or potential bottlenecks in memory, CPU, GPU, or software infrastructure of the edge device.

13. The system of claim 8, wherein the operations to select the resource-optimal AI model for deployment on the edge device based on the AI task capacity profile further comprise:
identifying an AI model family using the model and data descriptions and the AI task capacity profile; and
selecting a model variant of the AI model family based on the AI task capacity profile and resources of the edge device.

14. The system of claim 13, wherein the model variant is a compressed, pruned, or quantized AI model to correspond to resources of the edge device.

15. A computer program product comprising a computer readable storage medium having program instructions embodied therewith, the program instructions executable by a processor to cause the processor to perform operations comprising:
receiving a text-based service request for an artificial intelligence (AI) model for an edge device;
generating model and data descriptions using the text-based service request;
generating an AI task capacity profile; and
selecting a resource-optimal AI model for deployment on the edge device based on the AI task capacity profile.

16. The computer program product of claim 15, wherein the text-based service request comprises a description of an AI task, a description of an AI model architecture, a description of an input to the AI model, a description of an output of the AI model, an example of a deployment scenario of the AI model, an example of a specific use-case for the AI model, an example of a re-use of the AI model, a list of performance requirements of the AI model, or a list of generative prompts to the AI model.

17. The computer program product of claim 15, wherein the operations to generate the model and data descriptions using the text-based service request further comprise:
providing the text-based service request to a pre-trained large language model as input; and
generating the model and data descriptions using results received from the pre-trained large language model.

18. The computer program product of claim 15, wherein the operations to generate the AI task capacity profile further comprise:
retrieving a capacity profile of the edge device;
identifying performance and resource parameters by comparing the capacity profile of the edge device to an AI model requirements mapping; and
generating the AI task capacity profile using the performance and resource parameters.

19. The computer program product of claim 15, wherein the AI task capacity profile comprises a compatibility list that comprises hardware and software mismatches between a potential AI model and edge device or potential bottlenecks in memory, CPU, GPU, or software infrastructure of the edge device.

20. The computer program product of claim 15, wherein the operations to select the resource-optimal AI model for deployment on the edge device based on the AI task capacity profile further comprise:
identifying an AI model family using the model and data descriptions and the AI task capacity profile; and
selecting a model variant of the AI model family based on the AI task capacity profile and resources of the edge device.

21. The computer program product of claim 20, wherein the model variant is a compressed, pruned, or quantized AI model to correspond to resources of the edge device.

22. A computer-implemented method comprising:
receiving a service request for an artificial intelligence (AI) model for an edge device;
generating model and data specifications by using automated generative translations of the service request;
performing an AI task capacity profiling using the model and data specifications and a capacity profile of the edge device to identify a key performance parameter and a key resource parameter of the AI model; and
selecting the AI model for deployment on the edge device based on the key performance parameter and the key resource parameter.

23. The computer-implemented method of claim 22, where generating the model and data specifications by using the automated generative translations of the service request further comprise:
providing the service request to a pre-trained large language model as input; and
generating the model and data specifications using results generated by the pre-trained large language model.

24. A system comprising:
a memory having computer readable instructions; and
one or more processors for executing the computer readable instructions, the computer readable instructions controlling the one or more processors to perform operations comprising:
receiving a service request for an artificial intelligence (AI) model for an edge device;
generating model and data specifications by using automated generative translations of the service request;
performing an AI task capacity profiling using the model and data specifications and a capacity profile of the edge device to identify a key performance parameter and a key resource parameter of the AI model; and
selecting the AI model for deployment on the edge device based on the key performance parameter and the key resource parameter.

25. The system of claim 24, where the operations to generate the model and data specifications by using the automated generative translations of the service request further comprise:
providing the service request to a pre-trained large language model as input; and
generating the model and data specifications using results generated by the pre-trained large language model.
